(19) United States
(12) Patent Application Publication
(10) Pub. No.: US 2024/0285112 A1
(43) Pub. Date: Aug. 29, 2024

(54) MACHINE FOR COOKING FOOD IN A CONTAINER

(71) Applicant: PASTIFICIO RANA S.P.A., San Giovanni Lupatoto (IT)

(72) Inventor: Gian Luca RANA, San Giovanni Lupatoto (IT)

(21) Appl. No.: 18/289,956

(22) PCT Filed: May 11, 2022
(86) PCT No.: PCT/IB2022/054383

§ 371 Date: Nov. 8, 2023

(30) Foreign Application Priority Data
May 12, 2021 (IT) 102021000012230

(51) Int. Cl. A47J 27/04; A47J 27/00; A47J 27/10; A47J 27/16; A47J 27/18

(52) U.S. Cl. CPC A47J 27/04; A47J 27/10; A47J 27/16; A47J 27/18; A47J 2027/006; A47J 2027/043

(57) ABSTRACT

A machine for cooking food in a container has a frame comprising a plate having an upper face and a lower face; a dispenser supported by the plate along the lower face and comprising at least one first opening for dispensing steam into the container and at least one second opening for dispensing hot water into the container; a support configured to be arranged below the container and to support the container; and a mechanism coupled to the plate and comprising at least one elastic element for pushing the support towards the dispenser; and a command unit for counteracting the force of the elastic element and lowering the support with respect to the plate.

### CROSS-REFERENCE TO RELATED APPLICATIONS

This patent application is related to Italian Patent Application No. 102021000012230 filed on May 12, 2021, the entire disclosure of which is incorporated herein by reference.

### TECHNICAL FIELD OF THE INVENTION

The present invention relates to a machine for cooking food in a container.

In particular, the present invention relates to a machine for cooking food by means of the supply of hot water and steam.

### STATE OF THE ART

Within the scope of the quick catering industry, it is known to use machines for cooking fresh food and/or for heating precooked food by means of the use of steam.

Patent applications No. WO 2019/207509, No. WO 2020/212909 and No. WO 2020/212207 of the applicant teach how to cook fresh food contained in a container by means of the supply of hot water and steam in the container containing the food.

In the currently known machines, steam is dispensed into the container by a dispenser at temperatures above 100° C. Consequently, it is necessary to provide a coupling between the container and the dispenser that is stable and solid, so as to prevent undesired steam leakage from the container and that, at the same time, allows a quick replacement of the container, so as to meet the short cooking times required in the quick catering sector.

The object of the present invention is to provide a machine for cooking food that can easily and economically satisfy the needs set out above.

### SUBJECT AND SUMMARY OF THE INVENTION

According to the present invention, a machine for cooking food in a container is manufactured, the machine comprising:
a frame comprising a plate having an upper face and a lower face;
a dispenser supported by the plate along the lower face and comprising at least one first opening for dispensing steam into the container and at least one second opening for dispensing hot water into the container;
a support configured to be arranged below the container and to support the container; and
a mechanism coupled to the plate and to the support and comprising at least one elastic element for pushing the support towards the dispenser; and a command unit for counteracting the force of the elastic element and lowering the support with respect to the plate.

Thanks to the present invention, it is possible to ensure a solid and stable coupling between the dispenser and the container during the cooking of the food and, at the same time, it is possible to decouple the container from the dispenser so as to allow the replacement of the container in a simple and fast way.

In other words, the mechanism allows keeping the container pressed against the dispenser during the cooking process so as to prevent steam leakage from the container and separating the container from the dispenser, by operating the command unit, once the cooking process is finished.

In particular, the support has a plurality of openings.

In this way, it is possible to reduce the weight of the support and prevent any liquids from accumulating on the support.

In particular, the machine comprises a steam supply duct, which is in fluidic communication with the at least one first opening; and a hot water supply duct, which is in fluidic communication with the at least one second opening.

In this way, it is possible to independently supply steam and hot water respectively to the first opening and to the second opening.

In particular, the mechanism is configured to push the container against the dispenser so as to close an upper opening of the container and to form a substantially closed cooking compartment for cooking the food.

In this way, it is possible to ensure the sealing of the steam inside the container during the cooking process.

In particular, the dispenser comprises a lid configured to close the container, so as to form the substantially closed cooking compartment together with the container.

In particular, the support is movable in a direction substantially parallel to a longitudinal axis.

In this way, it is possible to control by means of the command unit the distance of the container from the dispenser.

In particular, the dispenser extends along the longitudinal axis from the plate towards the support in the space between the plate and the support.

In this way, the dispenser is substantially aligned with the movement direction of the support.

In particular, the mechanism comprises kinematic assembly of the connecting rod-crank type.

In this way, it is possible to convert a rotary motion given to the command unit into a translatory motion of the support.

In particular, the mechanism comprises a crossbar, which is movable in a direction substantially parallel to the longitudinal axis and is connected to the kinematic assembly of the connecting rod-crank type; and at least one guide, which extends in a direction parallel to the longitudinal axis and is connected to the movable crossbar and the support.

In this way, it is possible to guide the translatory movement of the crossbar and of the support in a direction substantially parallel to the longitudinal axis.

In particular, the kinematic assembly of the connecting rod-crank type comprises a shaft, which is rotatable about a transverse axis with respect to the longitudinal axis and is connected to the command unit; a crank body jointly coupled to the shaft; and a connecting rod body having a first end hinged to the crank body and a second end hinged to the movable crossbar.

The rotation of the shaft, controlled by the command unit, determines the rotation of the crank body and, consequently, the movement of the connecting rod body. In this way, it is possible to determine the translation of the movable crossbar along the longitudinal axis.

In particular, the elastic element is arranged between the movable crossbar and a blocking element fixed to the frame so as to counteract the movement of the movable crossbar towards the dispenser.

In particular, the mechanism comprises two lateral guides arranged on opposite bands with respect to the dispenser; each lateral guide being a rod comprising a first end connected to the movable crossbar and a second end connected to the support so as to transmit the translatory motion from the movable crossbar to the support.

In particular, the command unit comprises a hand lever so as to allow the support to be lowered manually.

### BRIEF DESCRIPTION OF THE DRAWINGS

Further characteristics and advantages of the present invention will become clear from the following description of a non-limiting example embodiment thereof, with reference to the accompanying figures, wherein:

FIG. 1 is a perspective view, with parts removed for clarity, of a machine for cooking food in a container in accordance with the present invention; and

FIG. 2 is a section view of a detail of the machine of FIG. 1.

### DETAILED DESCRIPTION OF PREFERRED EMBODIMENTS OF THE INVENTION

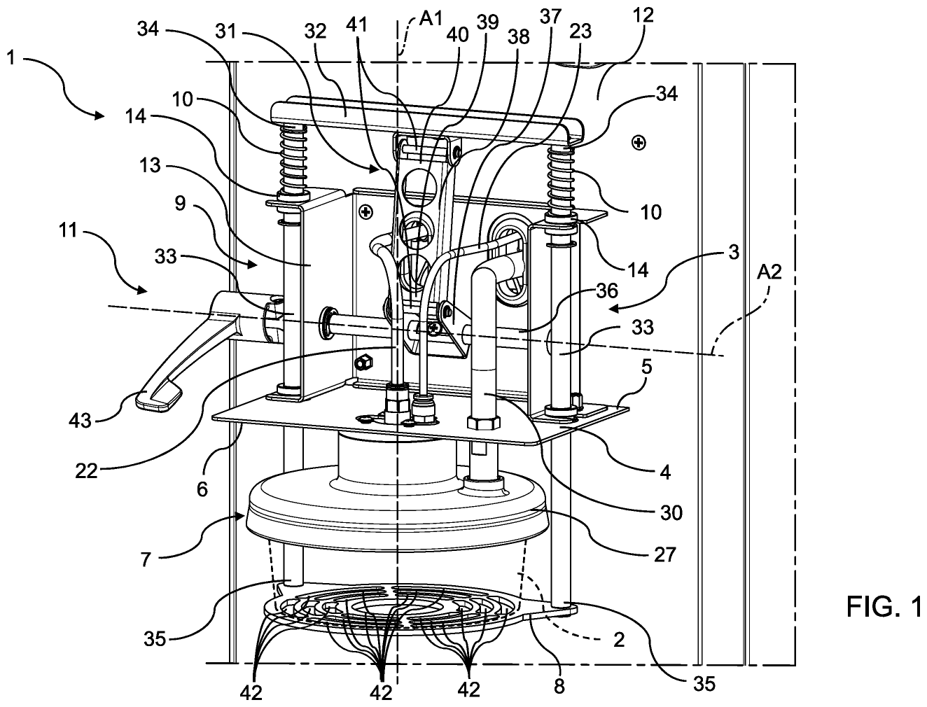

With reference to FIG. 1, reference numeral 1 indicates, as a whole, a machine for cooking food in a container 2 containing said food.

The machine 1 can be used in public catering places (for example coffee bars, restaurants, diners etc.) or at home.

In accordance with a non-limiting embodiment of the present invention, the food contained in the container 2 can be a dose of raw pasta or a sauce for said dose of pasta.

The machine 1 comprises a frame 3 comprising a plate 4 having an upper face 5 and a lower face 6; a dispenser 7 supported by the plate 4 along the lower face 6; a support 8 configured to be arranged below the container 2 and to support the container 2; and a mechanism 9 coupled to the plate 4 and to the support 8 and comprising at least one elastic element 10 for pushing the support 8 towards the dispenser 7; and a command unit 11 for counteracting the force of the elastic element 10 and lowering the support 8 with respect to the plate 4.

The frame 3 further comprises a casing 12, within which a first boiler and a second boiler, not shown in the accompanying figures, are arranged for respectively supplying steam and hot water to the dispenser 7; and a bearing 13, which is fixed to the casing 12 above the plate 4 and is provided with two annular-shaped blocking elements 14.

The dispenser 7 extends along a longitudinal axis A1 from the plate 4 towards the support 8 in the space between the plate 4 and the support 8.

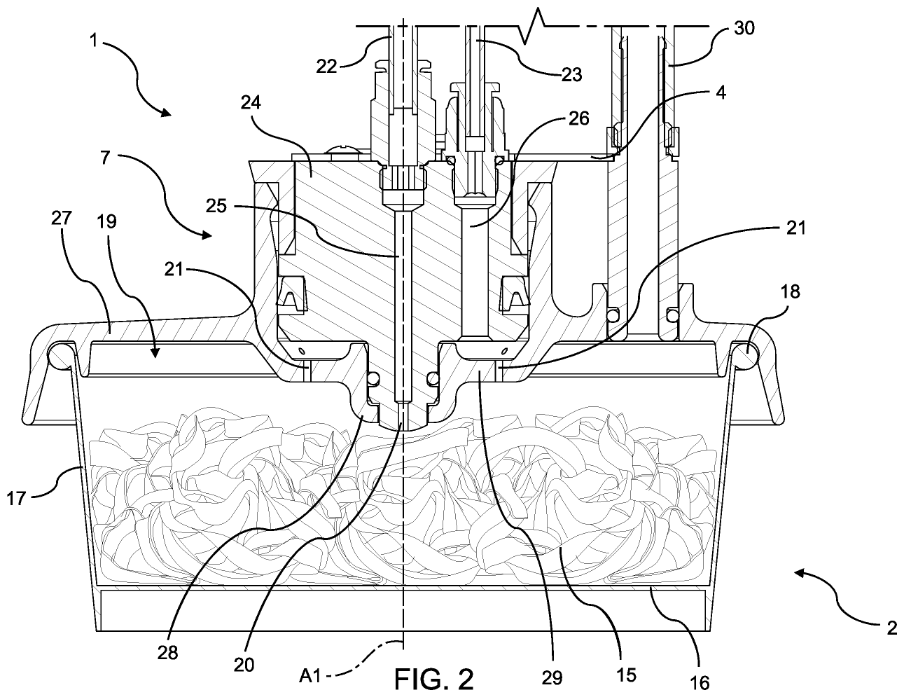

With reference to FIG. 2, the container 2 is configured to contain food 15 and comprises a base wall 16, preferably having a circular shape; a side wall 17, preferably slightly flared, provided with an upper edge 18; and an upper opening 19, preferably having a circular shape, opposite the base wall 16.

The dispenser 7 comprises at least one opening 20 for dispensing steam into the container 2 and at least one opening 21 for dispensing hot water into the container 2.

The machine 1 comprises a steam supply duct 22, which is in fluidic communication with the opening 20; and a hot water supply duct 23, which is in fluidic communication with the opening 21.

In the non-limiting case of the present invention described and illustrated herein, the dispenser 7 comprises a central body 24 provided with a steam supply channel 25, which is in fluidic communication with the duct 22 and with the opening 20, and with a hot water supply channel 26, which is in fluidic communication with the duct 23 and with the openings 21; and a lid 27, which is arranged about the central body 24 and is configured to close the upper opening 19 of the container 2 so as to form a substantially closed cooking compartment for cooking the food 15.

In particular, the central body 24 comprises a central protrusion 28, which is provided with the opening 20; and an annular wall 29, which extends about the central protrusion 28 and is provided with a plurality of openings 21.

The machine 1 further comprises a steam evacuation duct 30, which is configured to evacuate steam from the container 2 and is connected to a steam discharge, not shown in the accompanying figures. In particular, the duct 30 extends through the lid 27 so as to put the inside of the cooking compartment into fluidic communication with the steam discharge.

With reference to FIG. 1, the mechanism 9 is configured to push the container 2 against the dispenser 7 so as to close the upper opening 19 of the container 2 and to form the substantially closed cooking compartment.

In particular, the mechanism 9 comprises a kinematic assembly 31 of the connecting rod-crank type configured to convert a rotary motion given to the command unit 11 into a translatory motion of the support 8.

More specifically, the mechanism 9 comprises a crossbar 32, which is movable in a direction substantially parallel to the longitudinal axis A1 and is connected to the kinematic assembly 31; and at least one guide 33, which extends in a direction parallel to the longitudinal axis A1 and is connected to the crossbar 32 and the support 8.

In the case described and illustrated herein, the mechanism 9 comprises two lateral guides 33 arranged on opposite bands with respect to the dispenser 7. Each guide 33 extends through a respective opening of the plate 4 and inside the respective blocking element 14. In particular, each guide 33 is a rod comprising an end 34 connected to the movable crossbar 32 and an end 35 connected to the support 8.

The crossbar 32 faces the upper face 5 of the plate 4 and extends in a direction substantially transverse with respect to the longitudinal axis A1.

In particular, the mechanism 9 comprises two elastic elements 10, each of which is arranged between the crossbar 32 and the respective blocking element 14 so as to counteract the movement of the crossbar 32 towards the dispenser 7. In the present case, each elastic element 10 is a coil spring arranged about the respective guide 33.

The kinematic assembly 31 comprises a shaft 36, which is rotatable about a transverse axis A2 with respect to the longitudinal axis A1 and is connected to the command unit 11; a crank body 37 jointly coupled to the shaft 36; and a connecting rod body 38 provided with an end 39 hinged to the crank body 37 and with an end 40 hinged to the crossbar 32.

In particular, the connecting rod body 38 is hinged to the crank body 37 and to the crossbar 32 by means of respective pins 41, which allow the relative rotation between the connecting rod body 38 and the crank body 37 and between the connecting rod body 38 and the crossbar 32.

More specifically, the support 8 is jointly coupled to the crossbar 32 through the guides 33 and is movable in a direction substantially parallel to the longitudinal axis A1. Also, the support 8 has a plurality of openings 42.

In the case described and illustrated herein, the command unit 11 comprises a hand lever 43, configured to be operated by an operator assigned to the machine 1. More specifically, the hand lever 43 is configured to actuate the rotation of the shaft 36.

In use and with reference to FIG. 1, an operator operates the command unit 11 by turning the hand lever 43 clockwise. The operation of the command unit 11 determines the rotation of the shaft 36 and of the crank body 37, which in turn moves the connecting rod body 38 and the crossbar 32.

In particular, the end 40 of the connecting rod body 38 describes a translatory motion in a direction substantially parallel to the longitudinal axis A1 towards the plate 4 and drags the crossbar 32 to which it is hinged.

Since the crossbar 32 is connected to the support 8 by means of the guides 33, the translation of the crossbar 32 determines the lowering of the support 8 with respect to the dispenser 7.

At this point the operator places the container 2 containing food 15 on the support 8 and releases the hand lever 43.

Thanks to the action of the elastic elements 10, which determine respective forces on the crossbar 32 in directions substantially parallel to the longitudinal axis A1 and directed upwards, the support 8 is brought back towards the dispenser 7 and the container 2 is pushed with a given pressure against the lid 27 of the dispenser 7. In this way, the dispenser 7 and the container 2 form a substantially closed cooking compartment.

Subsequently, the dispenser 7 dispenses steam and hot water into the container 2 respectively from the opening 20 and from the openings 21 simultaneously and/or according to any sequence so as to cook the food 15 according to a given recipe.

Once the cooking of the food 15 is finished, the operator of the machine 1 operates the command unit 11 again by turning the hand lever 43 so as to lower the support 8 and separate the container 2 from the dispenser 7 allowing the removal of the container 2 from the support 8.

It is evident that variations can be made to the present invention without thereby departing from the scope of protection of the appended claims.

1. A machine for cooking food in a container, the machine comprising:
a frame comprising a plate having an upper face and a lower face;
a dispenser supported by the plate along the lower face and comprising at least one first opening for dispensing steam into the container and at least one second opening for dispensing hot water into the container;
a support configured to be arranged below the container and to support the container; and
a mechanism coupled to the plate and to the support and comprising at least one elastic element for pushing the support towards the dispenser; and a command unit for counteracting the force of the elastic element and lowering the support with respect to the plate.

2. The machine as claimed in claim 1, wherein the support has a plurality of openings.

3. The machine as claimed in claim 1, and comprising a steam supply duct, which is in fluidic communication with the at least one first opening; and a hot water supply duct, which is in fluidic communication with the at least one second opening.

4. The machine as claimed in claim 1, wherein the mechanism is configured to push the container against the dispenser so as to close an upper opening of the container and to form a substantially closed cooking compartment for cooking the food.

5. The machine as claimed in claim 4, wherein the dispenser comprises a lid configured to close the container.

6. The machine as claimed in claim 1, wherein the support is movable in a direction substantially parallel to a longitudinal axis.

7. The machine as claimed in claim 6, wherein the dispenser extends along the longitudinal axis from the plate towards the support in the space between the plate and the support.

8. The machine as claimed in claim 6, wherein the mechanism comprises a kinematic assembly of the connecting rod-crank type.

9. The machine as claimed in claim 8, wherein the mechanism comprises a crossbar, which is movable in a direction substantially parallel to the longitudinal axis and is connected to the kinematic assembly of the connecting rod-crank type; and at least one guide, which extends in a direction parallel to the longitudinal axis and is connected to the movable crossbar and the support.

10. The machine as claimed in claim 9, wherein the kinematic assembly of the connecting rod-crank type comprises a shaft, which is rotatable about a transverse axis with respect to the longitudinal axis and is connected to the command unit; a crank body jointly coupled to the shaft; and a connecting rod body having a first end hinged to the crank body and a second end hinged to the movable crossbar.

11. The machine as claimed in claim 9, wherein the elastic element is arranged between the movable crossbar and a blocking element fixed to the frame so as to counteract the movement of the movable crossbar towards the dispenser.

12. The machine as claimed in claim 9, wherein the mechanism comprises two lateral guides arranged on opposite bands with respect to the dispenser; each lateral guide being a rod comprising a first end connected to the movable crossbar and a second end connected to the support.

13. The machine as claimed in claim 1, wherein the command unit comprises a hand lever.
